(19) United States
(12) Patent Application Publication
(10) Pub. No.: US 2009/0229458 A1
(43) Pub. Date: Sep. 17, 2009

(54) FILTER ELEMENT ARRANGEMENT INCLUDING BYPASS ARRANGEMENT AND METHODS

(76) Inventors: Terrance D. Feddersen, Belle Plaine, MN (US); Fred H. Wahlquist, Bloomington, MN (US); Robert Paul Widerski, Saint Paul, MN (US)

Correspondence Address: MERCHANT & GOULD PC, P.O. BOX 2903, MINNEAPOLIS, MN, 55402-0903, US

(21) Appl. No.: 12/045,888

(22) Filed: Mar. 11, 2008

(51) Int. Cl. B01D 46/46

(52) U.S. Cl. 95/19; 55/311

(57) ABSTRACT

A filter element includes a panel construction of filter media; a filter frame holds a periphery of the panel construction; and a bypass arrangement is adjacent to the panel construction. The bypass arrangement includes a door moveable between a closed position and an open position, and a force member holding the door in the closed position until restriction across the filter media reaches a predetermined amount to allow the door to move to the open position. An example force member is a magnet arrangement or a spring. The element is installable in an air cleaner assembly. A method of filtering air directs a flow of air into a housing holding a panel filter element, and prevents bypassing of the filter element by having a bypass door remain closed by exerting a first closing force on the bypass door. The method further includes a step of opening the bypass door, when the restriction across the panel filter element causes a second force that exceeds the first closing force, to allow air flow to bypass the panel filter element and flow through an opening exposed by the door.

### TECHNICAL FIELD

This disclosure relates to filtration of fluid systems. In particular, this disclosure concerns filtration of air in an arrangement that includes a bypass door moveable between a closed position and an open position.

### BACKGROUND

Filtration of air is important in order to remove particulate material from the air flow stream. This is important in situations in which the air flow stream is used in downstream equipment such as engines, compressors, and generators. Filtration of air is also important in closed environments, such as closed cabins in airplanes or helicopters.

Filtration usually involves having filter media to allow for air to pass through the media while the media catches the particulate material. Over time, and if used in environments where there is much dust or other particulate material in the air, the media will become occluded. When this happens, the pressure drop across the filter media increases. Restriction of air flow through the media increases. When restriction increases, less air is allowed to flow through the media and to the downstream equipment. The reduced amount of air flow getting to the downstream equipment can cause operational problems in the downstream equipment. Thus, it is desirable to have a system in which the air is allowed to bypass the media if the restriction increases to an unacceptably high level.

### SUMMARY OF THE DISCLOSURE

In accordance with principles of this disclosure, a filter element is provided. The filter element includes a panel construction of filter media having an upstream flow face and an opposite downstream flow face. A bypass arrangement is adjacent to the panel construction. The bypass arrangement includes a door moveable between a closed position and an open position, and a force member holding the door in the closed position until restriction across the filter media reaches a predetermined amount to allow the door to move to the open position.

In one example embodiment, the door extends a length of the filter media and is hingedly connected to the bypass frame.

In one embodiment, the force member comprises a magnet arrangement holding the door in the closed position until the restriction across the filter media reaches the predetermined amount.

In one example embodiment, the bypass arrangement is at an end of the filter media, while in another embodiment, the bypass arrangement is between two sections of filter media.

In another aspect, an air cleaner assembly is provided. The air cleaner assembly includes a housing having a housing wall defining an interior, an inlet for receiving air to be filtered, and an outlet for exhausting filtered air. A filter element is operably mounted and sealed within the interior of the housing. The filter element includes a panel construction of filter media oriented in the interior such that air flows from the inlet, through an upstream flow face, through the filter media, out through the downstream flow face, and then through the outlet. A bypass arrangement is provided and includes a door moveable between a closed position, which closes an air flow bypass opening, and an open position which exposes an air flow bypass opening. The closed position blocks air flow through the bypass opening, the open position permits air flow through the bypass opening. A force member holds the door in the closed position until restriction across the filter media reaches a predetermined amount to allow the door to move to the open position permitting air to bypass the filter media and flow through the bypass opening.

In another aspect, a method of filtering air comprises directing a flow of air into a housing holding a panel filter element, and preventing bypassing of the filter element by having a bypass door remain closed by exerting a first closing force on the bypass door. The method further includes a step of opening the bypass door, when the restriction across the panel filter element causes a second force that exceeds the first closing force, to allow air flow to bypass the panel filter element and flow through an opening exposed by the door.

### BRIEF DESCRIPTION OF THE DRAWINGS

FIG. 1 is a front elevational view of a filter element constructed according to principles of this disclosure;

FIG. 2 is a right side elevational view of the filter element of FIG. 1;

FIG. 3 is a bottom plan view of the element of FIG. 1;

FIG. 4 is a schematic perspective view with parts broken away, of the filter element of FIGS. 1-3;

FIG. 5 is a rear elevational view of a door assembly utilized in the filter element of FIGS. 1-4;

FIG. 6 is a bottom plan view of the door assembly of FIG. 5;

FIG. 7 is a left side elevational view of the door assembly of FIG. 5;

FIG. 8 is a schematic side elevational view of an air cleaner utilizing the filter element of FIGS. 1-4;

FIG. 9 is a front elevational view of an alternate embodiment of a filter element constructed according to principles of this disclosure; and

FIGS. 10A and 10B are schematic views depicting an alternate embodiment of a force member and door in the bypass arrangement.

### DETAILED DESCRIPTION

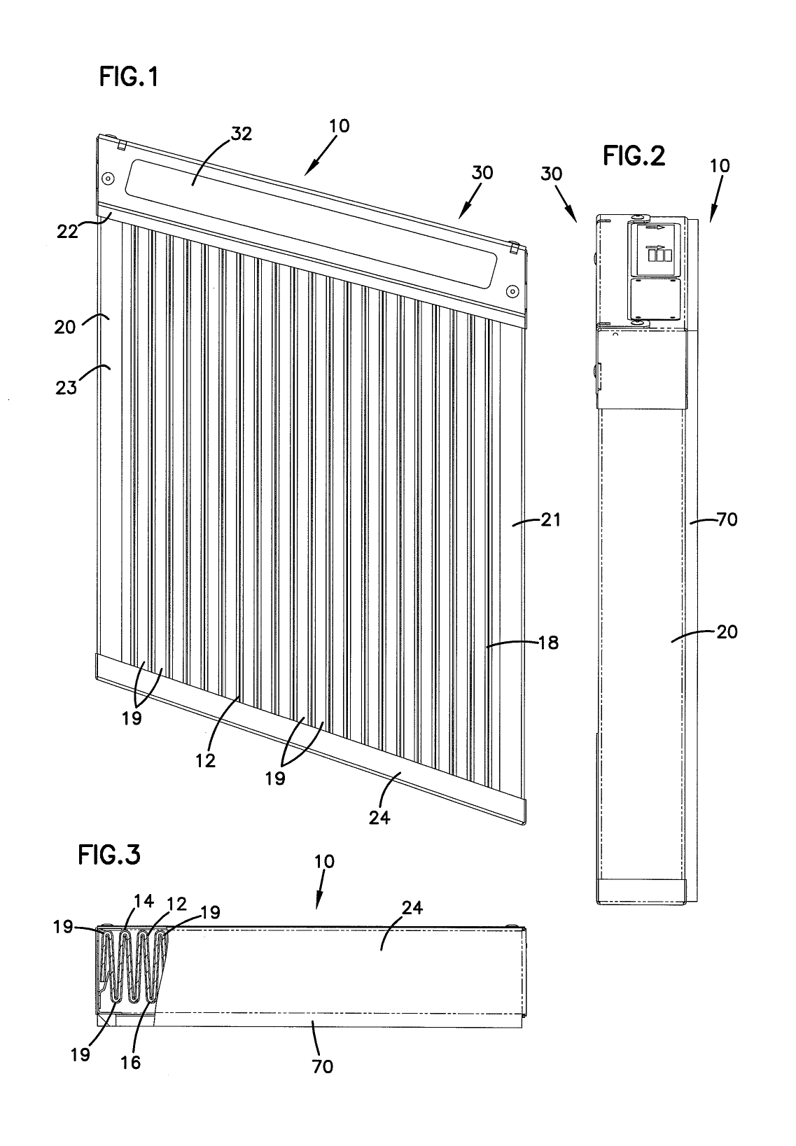

One embodiment of a filter element is illustrated in FIG. 1 at 10. The filter element 10 includes filter media 12 having an upstream flow face 14 and an opposite downstream flow face 16. In the embodiment shown, the media 12 is embodied in the form of a panel construction 18, such that the fluid flow is in a straight direction and does not need to turn a corner.

A variety of types of filter media 12 are usable. Such media can include depth media, pleated media or Z-media. By the term “Z-media”, it is meant filter media having a plurality of flutes, each flute having an end adjacent the upstream flow face and adjacent to the downstream flow face, with selected flutes being closed adjacent to the upstream flow face while being open adjacent to the downstream flow face, and selected flutes being open adjacent to the upstream flow face while being closed adjacent to the downstream flow face. The flutes can be straight, tapered, or darted. Examples of filter elements with Z-media are found in, for example, U.S. Pat. No. 5,820,646; Patent Publication 2003/0121845; and U.S. Pat. No. 6,350,291, each of these patent documents being incorporated by reference herein. Whatever type of media is utilized, the media may also include micro or nano-fibers, such as fibers described in U.S. Pat. Nos. 6,673,136, 6,974,490, 7,090,712, 7,270,692, 6,743,273, 6,924,028, 7,270,693, 7,070,640 & 7,179,317, incorporated herein by reference.

In the particular embodiment illustrated, the media 12 is depicted as pleated media. The pleated media can be made out of whatever type of material is best usable for the fluid being filtered, and in many applications, will be cellulose. The pleat depth, again, will be selected based upon the particular system in which it is filtering, including rated air flow, desired restriction, and desired filter life. Usable examples, include, for example, media with a pleat depth of 0.5-3 inches, for example 1.25-1.75 inches.

The filter media 12 can have an outer periphery selected to best fit the system which it is being used in. In the embodiment shown, the panel construction 18 of filter media 12 is embodied as a trapezoid. Other shapes are usable.

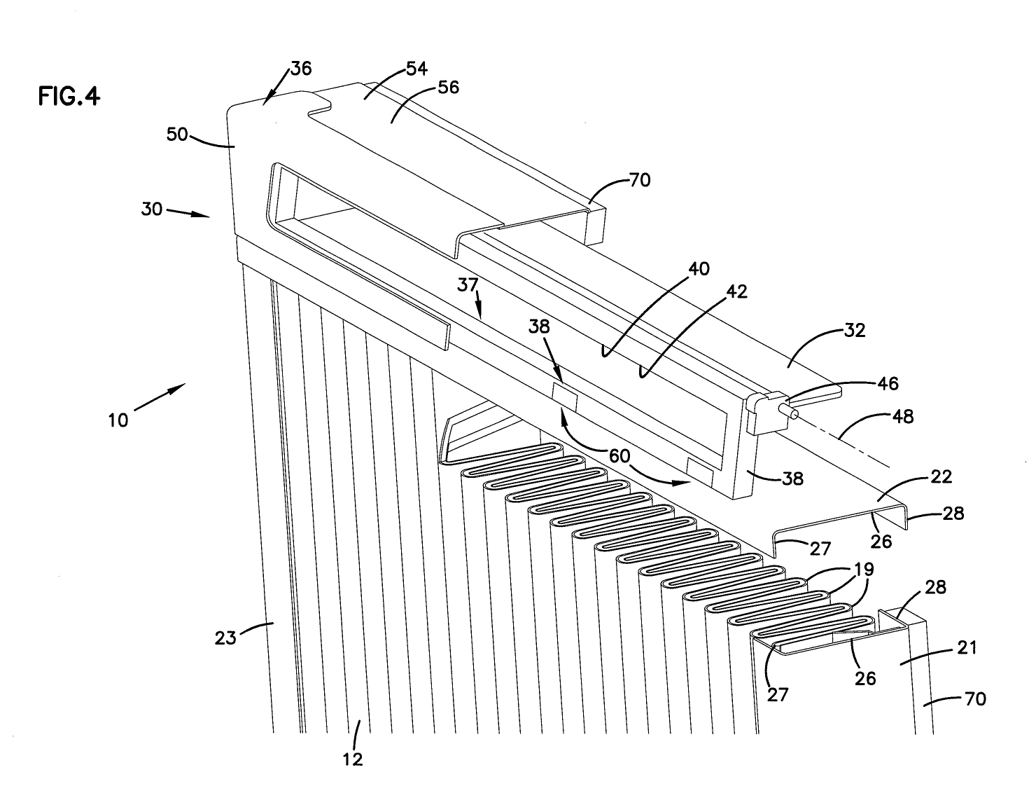

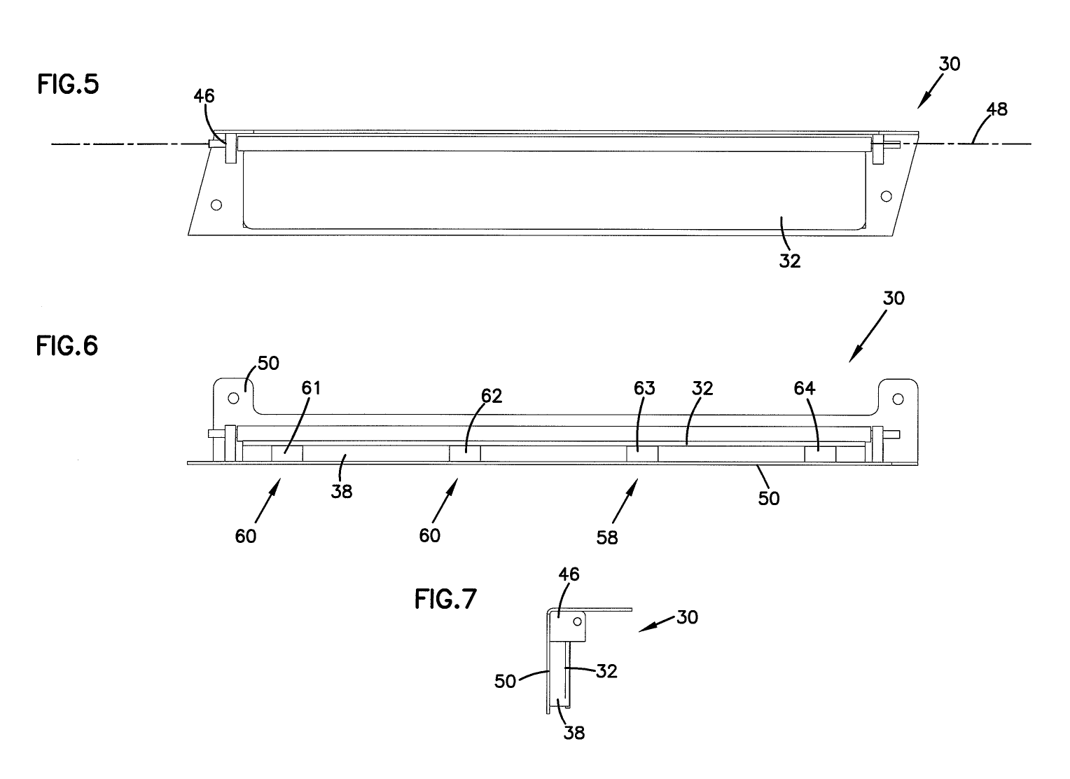

In accordance with principles of this disclosure, the filter media 10 includes a filter frame holding a periphery of the panel construction. In the embodiment shown, the filter frame 20 holds the periphery of the filter media 12. The filter frame 20 can include a single frame member 21 that is bent to surround the periphery, or it include a plurality of separate and distinct frame pieces 21 connected together to hold the media 12. The embodiment shown includes four frame pieces at 21, 22, 23, and 24. Each frame piece 21-24 can be embodied in many different structures, but in the embodiment shown, each frame piece 21-24 has a C-shaped cross section, including a base 26 with a pair of arms 27, 28 (FIG. 4). In the embodiment shown, frame pieces 21 and 23 are parallel to each other and also parallel to the direction of the pleats 19. Frame piece 21 is longer than frame piece 23, although in other embodiments, they could be of equal length or piece 21 could be shorter than piece 23. In the embodiment shown, frame pieces 22 and 24 are not parallel to each other and are angled relative to the frame pieces 21 and 23 and also angled relative to the direction to the pleats 19.

As can be seen in the embodiment of FIG. 4, the media 12 is held within the frame pieces 21-24 by being secured to the base 26 between the arms 27, 28. The media 12 can be secured to the frame pieces 21-24 through a variety of mechanisms such as by adhesive, by potting, by urethane, or by other suitable techniques. The frame member 20 including frame pieces 21-24 can be made from a variety of materials including metal, such as aluminum, steel, or combinations thereof.

In the embodiment shown, the filter frame 20 has a same outer periphery as the filter media 12. As such, in the embodiment shown, the filter frame 20 forms a trapezoid.

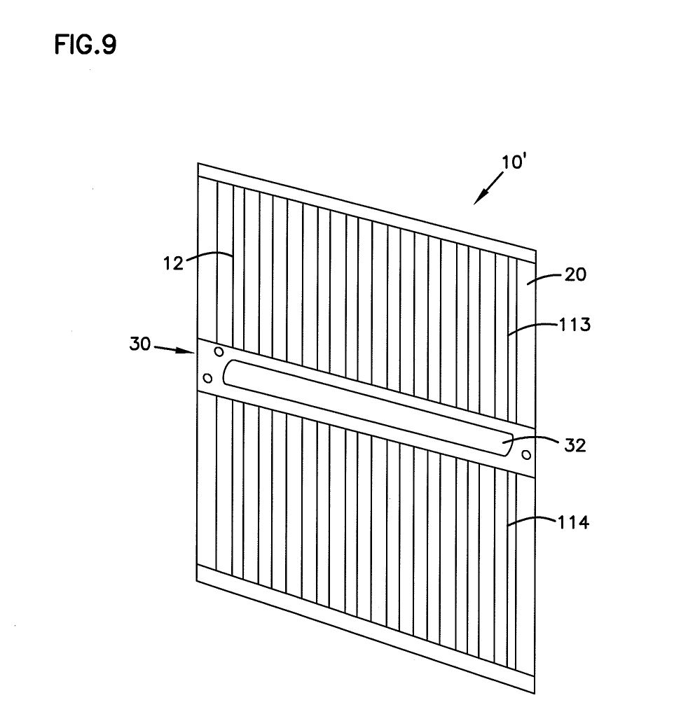

In accordance with principles of this disclosure, the filter element 10 includes a bypass arrangement that remains closed until restriction across the filter media reaches a predetermined amount, and then opens to permit air to bypass the filter media 12 and flow through a bypass opening. In preferred arrangements, the bypass arrangement 30 includes a door 32 moveable between a closed position (FIG. 1) and an open position (FIG. 4). In preferred arrangements, the bypass arrangement 30 further includes a force member that holds the door 32 in the closed position until restriction across the filter media 12 reaches a predetermined amount to allow the door 32 to move to the open position. The bypass arrangement 30 will be adjacent to the filter media 12. By “adjacent” it is meant that the bypass arrangement can be located any convenient place within the filter element 10, such as between sections of filter media or at various ends. In one example embodiment shown in FIG. 9, the bypass arrangement 30 is located between two sections of filter media 12, including being centered between the two sections of media (FIG. 9, discussed further below). In another illustrated embodiment, shown in FIGS. 1-4, the bypass arrangement 30 is located at an end of the panel construction 18, and in particular, adjacent to frame piece 22.

In the embodiment shown, the door 32 is shown as a generally flat, straight structure that is oriented relative to the rest of the filter element 10 to allow it to move between its closed position and open position. In the embodiment shown, the bypass arrangement 30 includes a bypass frame 36 secured to the filter frame 20; and a gasket arrangement 37.

The gasket arrangement 37 generally helps to provide a seal between the bypass frame 36 and the door 32. In the embodiment shown, the gasket arrangement 37 is depicted as a picture-frame style rectangular gasket 38 defining an open aperture 40. The aperture 40, defined by the border of the gasket 38 functions as a bypass opening 42. The door 32 is moveable from the closed position (FIG. 1) in which the door 32 blocks the bypass opening 42, and an open position (FIG. 4), in which the bypass opening 42 is exposed. In preferred arrangements, the cross-sectional area of the bypass opening 42 will be at least 4%, and typically 6-7% of the overall cross-sectional area of the upstream flow face 14 of the media 12. It will typically be no greater than 10% of the area of the upstream flow face 14 of the media 12. As can be seen in FIG. 4, the bypass opening 42 can extend between 80%-110% of the length of the media 12. The door 32 will preferably be made from metal, such as steel, because it cooperates with the force member, described below.

The door 32 can be made moveable relative to the bypass frame 36 in a variety of mechanisms. In the embodiment shown in FIG. 4, the door 32 is moveable relative to the gasket 38 by a hinge connection 46 to allow pivoting motion of the door 32 relative to the pivot axis 48 defined by the hinged connection 46.

The bypass frame 36 includes a bypass panel assembly 50. The gasket 38, in the embodiment shown, is held by the bypass panel assembly 50 through adhesive and other such ways. Panel assembly 50 can also include end piece 54 forming an end 56 of the bypass arrangement 30.

In accordance with principles of this disclosure, the bypass arrangement 30 includes a force member 58 holding the door 32 in the closed position until the restriction across the filter media 12 reaches a predetermined amount to allow the door 32 to be in the open position exposing the bypass opening 42. While a variety of mechanisms can be used, in the embodiment shown, the force member 58 comprises a magnet arrangement 60. The magnet arrangement 60 holds the door by use of having a magnetic field exposed to the metal door 32. The magnetic field of the magnet arrangement 60 attracts the door 32 against the gasket 38 to block the bypass opening 42. In the embodiment shown, the magnet arrangement 60 includes at least one magnet 61 secured to the bypass frame 36. In this specific embodiment shown, the magnet arrangement 60 includes four magnets 61, 62, 63, and 64 secured to the panel assembly 50.

In the embodiment shown, the magnets 61-64 are oriented to be in direct contact with the door 32. The magnets 61-64 attract the door 32 and hold it securely against the gasket 38 to hold the door 32 in a position that blocks the bypass opening 42.

In use, the magnet arrangement 60 exerts a certain, predetermined force on the door 32 to hold it to a closed position. When air flows across the filter media 12, eventually the media will become blocked or occluded, increasing the restriction across the media. Eventually, for a certain rated air flow, the force by the air on the upstream flow face 14 of the filter media 12 will increase to a level in which it is greater than the force exerted by the magnet arrangement 60 holding the door 32 closed. At this point, the force will cause the door 32 to pivot along the pivot axis 48 on the hinge connection 46, moving the door 32 away from the gasket 38 to expose the bypass opening 42. This will then allow air to flow through the bypass opening 42.

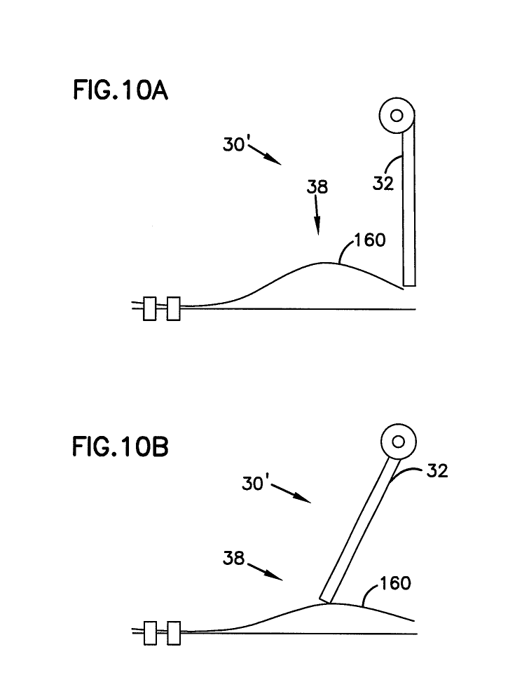

The force member 38 could be other structures, including springs such as a leaf spring 160 (FIGS. 10A and 10B). In FIGS. 10A and 10B, an alternate embodiment of bypass arrangement 30′ includes as the force member 38, leaf spring 160 to apply a force on door 32. In FIG. 10A, the door 32 is in the closed position, being held there by spring 160. In FIG. 10B, it can be seen how the leaf spring 160 has deflected and was forced in a flatter position as the door 32 was forced over the spring 160, when the door 32 moved to the open position.

Although springs, such as the leaf spring 160 can be used, magnet arrangement 60 has been found to be desirable because once the threshold pressure drop is reached to cause the door 32 to move away from the gasket 38 to expose the opening 42, there is no longer a significant force trying to pull the door 32 back to the closed position, as would be the case with a spring. Alternatively, with certain types of springs (such as leaf spring 160), once the threshold pressure drop is reached, triggering the door 32 to expose the opening 42, the spring 160 and door 32 would need to be “re-set” after triggering—in other words, the door 32 would need to be physically pushed back to the closed position over leaf spring 160 from the position of FIG. 10B to the position of FIG. 10A. By using the magnet arrangement 60, there are advantages over springs in that there is no significant “spring force” that would be trying to pull the door 32 back toward the gasket 38 to the closed position after opening, and there is no need to re-set the magnet arrangement 60 after the door 32 moves to the open position.

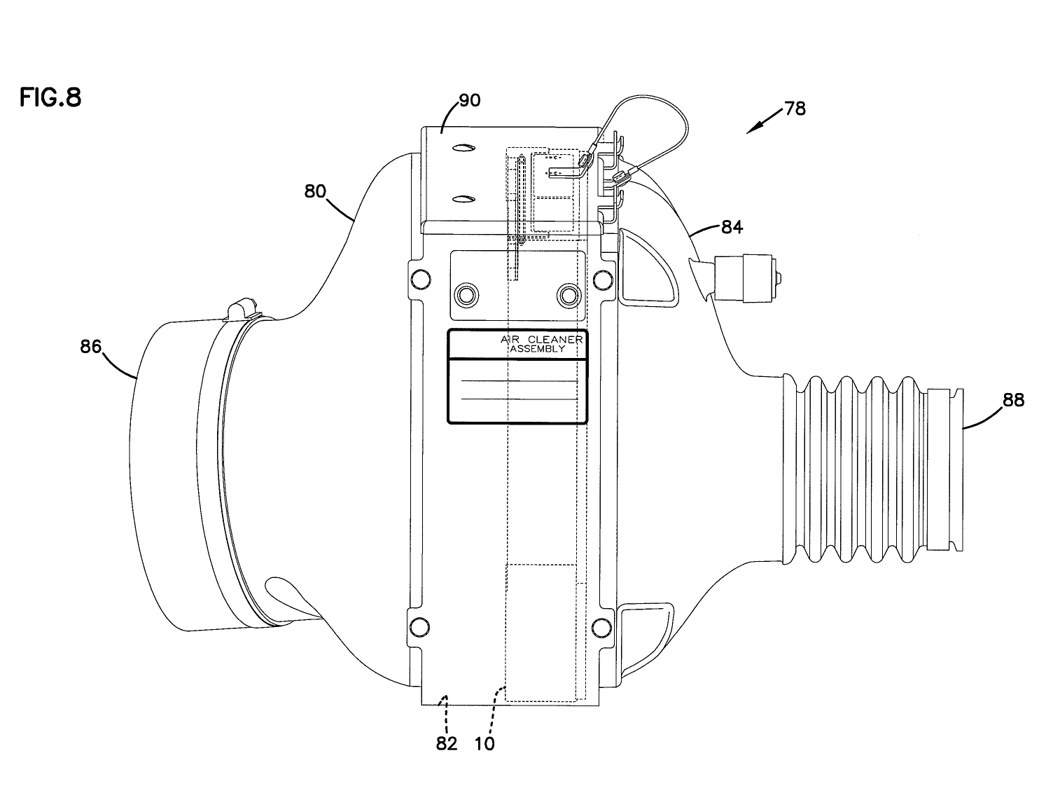

Filter element 10 further includes filter gasket 70. The gasket 70 is for providing a seal between the filter element 10 and a housing 80 (FIG. 8) in which the filter element 10 is installed. In preferred embodiments, the gasket 70 is secured to the filter frame 20. As can be seen in FIGS. 2, 3, and 4, the gasket 70 is secured to at least frame pieces 21, 23, and 24. In the embodiment shown, the gasket 70 is also secured to end of piece 54 of the bypass frame 36. The function of the gasket 70 is to provide a seal between the filter element 10 and the housing 80 in which it is installed so that air to be filtered cannot bypass the filter element 10 by flowing between a space between the element 10 and the housing 80.

FIG. 9 shows element 10′ with the bypass arrangement 30 located adjacent to the filter media 12, by being located between first and second sections 113, 114 of media 12. In the FIG. 9 embodiment, the filter element 10′ can be otherwise constructed analogously as the element 10 of FIGS. 1-4, including frame 20. In the FIG. 9 embodiment, the bypass arrangement 30 is approximately centered between the media sections 113, 114, but in other embodiments, the bypass arrangement can be located at any place within the element 10. In the FIG. 9 embodiment, because of the relatively symmetrical arrangement, the restriction across the media 12 and the door 32 is more evenly distributed than the embodiment of FIGS. 1-4 and can be useful when even distribution of restriction is an important factor.

In FIG. 8, an air cleaner assembly 78 includes the filter housing 80 with the filter element 10 removably and replaceably installed within. The element 10 is depicted in hidden lines, shown installed within an interior 82 of the housing 80. The housing 80 includes a housing wall 84 defining the interior 82. Housing 80 includes a housing inlet 86 for receiving air to be filtered and an outlet 88 for exhausting filtered air. The filter element 10 is installed in the housing interior 84 between the inlet 86 and outlet 88. The housing 80 also includes a service cover 90 that allows the interior 82 of the housing 80 to be accessed in order to change the filter element 10 when the filter life has been reached. The air cleaner assembly 78 can be used to clean air upstream of equipment such as a compressor, or an engine, for example.

In use, air to be filtered enters the housing inlet 86, flows through the upstream flow face 14 of the element 10, to the downstream flow face 16 of the element 10 and then out through the outlet 88 of the housing 80. When restriction across the filter media 12 exceeds a predetermined amount, the force impacting the media 12 will exceed the force being exerted by force member 38, such as the magnet arrangement 60. This will allow the bypass arrangement 30 to open the door 32 exposing the bypass opening 42. The bypass arrangement 30 will move from the closed position to the open position and the pressure across the filter element 10 including the door 32, reaches a predetermined value, such as about 24-26 inches of water. A typical rated air flow will be about 605 CFM. Once the pressure again drops, the door 32 will return to the closed position, blocking the bypass opening 42 and will be held closed by the magnet arrangement 60. If leaf spring 160 is used, the user will physically push the door 32 over the leaf spring 160 from the open position to the closed position, blocking the bypass opening 42 to “re-set” the door 32 and spring 160.

We claim:

1. A filter element comprising:
(a) a panel construction of filter media having an upstream flow face and an opposite downstream flow face; and
(b) a bypass arrangement adjacent to the filter media, the bypass arrangement including:
(i) a door movable between a closed position, closing an air flow bypass opening, and an open position exposing an air flow bypass opening; the closed position blocking air flow through the bypass opening and the open position permitting air flow through the bypass opening; and
(ii) a force member holding the door in the closed position until restriction across the filter media reaches a predetermined amount to allow the door to move to the open position permitting air to bypass the filter media and flow through the bypass opening.

2. A filter element according to claim 1 wherein:
(a) the filter media comprises pleated media.

3. A filter element according to claim 1 further including:
(a) a filter frame holding a periphery of the panel construction.

4. A filter element according to claim 3 further including:
(a) a gasket secured to the frame.

5. A filter element according to claim 3 wherein:
(a) the bypass arrangement includes a bypass frame secured to the filter frame;
(b) the door extends a length of the filter media and is hingedly connected to the bypass frame.

6. A filter element according to claim 3 wherein:
(a) the filter frame is a trapezoid shape.

7. A filter element according to claim 6 wherein:
(a) the panel construction of filter media is a trapezoid shape.

8. A filter element according to claim 1 wherein:
(a) the bypass opening extends between 80%-110% of the length of the media.

9. A filter element according to claim 1 wherein:
(a) a cross-sectional area of the bypass opening is at least 4% and not greater than 10%, inclusive, of a cross-sectional area of the upstream flow face.

10. A filter element according to claim 1 wherein:
(a) the force member comprises a magnet arrangement holding the door in the closed position until the restriction across the filter media reaches the predetermined amount.

11. A filter element according to claim 10 wherein:
(a) the magnet arrangement includes at least one magnet secured to the bypass frame.

12. A filter element according to claim 1 wherein:
(a) the force member comprises a spring holding the door in the closed position until restriction across the filter media reaches the predetermined amount.

13. A filter element according to claim 1 wherein:
(a) the bypass arrangement is oriented adjacent to an end of the panel construction.

14. A filter element according to claim 1 wherein:
(a) the bypass arrangement is oriented between first and second sections of filter media.

15. A filter element according to claim 14 wherein:
(a) the bypass arrangement is centered between first and second sections of filter media.

16. An air cleaner assembly comprising:
(a) a housing having a housing wall defining an interior, an inlet for receiving air to be filtered, and an outlet for exhausting filtered air; and
(b) a filter element operably mounted and sealed within the interior of the housing; the filter element including:
(i) a panel construction of filter media having an upstream flow face and an opposite downstream flow face;
(A) the panel construction oriented in the interior such that air flows from the inlet, through the upstream flow face, through the filter media, out through the downstream flow face, and then through the outlet;
(ii) a bypass arrangement adjacent to the panel construction; the bypass arrangement including:
(A) a door movable between a closed position, closing an air flow bypass opening, and an open position exposing an air flow bypass opening; the closed position blocking air flow through the bypass opening and the open position permitting air flow through the bypass opening; and
(B) a force member holding the door in the closed position until restriction across the filter media reaches a predetermined amount to allow the door to move to the open position permitting air to bypass the filter media and flow through the bypass opening.

17. An air cleaner assembly according to claim 16 wherein:
(a) the bypass arrangement includes a bypass frame; and
(b) the door extends a length of the filter media and is hingedly connected to the bypass frame.

18. An air cleaner assembly according to claim 16 wherein:
(a) the force member comprises a magnet arrangement holding the door in the closed position until the restriction across the filter media reaches the predetermined amount.

19. An air cleaner assembly according to claim 16 wherein:
(a) the force member comprises a spring holding the door in the closed position until the restriction across the filter media reaches the predetermined amount.

20. An air cleaner assembly according to claim 16 wherein:
(a) the panel construction of filter media is a trapezoid shape;
(b) the filter media comprises pleated media;
(c) the filter element is removable and replaceable from the housing; and
(d) the filter element includes a gasket secured to the frame to provide a releasable seal between the filter element and the housing.

21. An air cleaner assembly according to claim 16 wherein:
(a) the bypass arrangement is oriented adjacent to an end of the panel construction.

22. An air cleaner assembly according to claim 16 wherein:
(a) the bypass arrangement is oriented between first and second sections of filter media.

23. A method of filtering air comprising:
(a) directing a flow of air into a housing holding a panel filter element; and
(b) preventing bypassing of the panel filter element by having a bypass door remain closed by exerting a first closing force on the bypass door; and
(c) when the restriction across the panel filter element causes a second force that exceeds the first closing force, opening the bypass door to allow air flow to bypass the panel filter element and flow through an opening exposed by the door.

24. A method according to claim 23 wherein:
(a) the step of preventing bypassing includes exerting a magnetic force on the bypass door to keep the door closed.

25. A method according to claim 23 wherein:
(a) the step of opening the bypass door includes allowing the door to pivot on a hinge relative to a bypass frame.
